(19) United States
(12) Patent Application Publication
(10) Pub. No.: US 2011/0000508 A1
(43) Pub. Date: Jan. 6, 2011

(54) METHOD OF REMOVING RESIDUAL FLUORINE FROM DEPOSITION CHAMBER

(75) Inventor: Jun SONOBE, Tsukuba-shi (JP)

Correspondence Address: American Air Liquide, Inc.;Intellectual Property Dept., 2700 Post Oak Boulevard, Suite 1800, Houston, TX, 77056, US

(73) Assignee: L'Air Liquide, Societe Anonyme pour I'Etude et l'Exploitation des Procedes Georges Claude, Paris (FR)

(21) Appl. No.: 12/827,128

(22) Filed: Jun. 30, 2010

Related U.S. Application Data
(60) Provisional application No. 61/222,724, filed on Jul. 2, 2009.

(51) Int. Cl. B08B 9/00

(52) U.S. Cl. 134/22.1

(57) ABSTRACT

Disclosed are methods to remove residual fluorine left in a chamber surface without the use of a plasma device or temperature elevation. The disclosed methods may permit the next step in the deposition process to occur more quickly.

### CROSS-REFERENCE TO RELATED APPLICATIONS

This application claims the benefit under 35 U.S.C. § 119(e) to provisional application Ser. No. 61/222,724, filed Jul. 2, 2009, the entire contents of which are incorporated herein by reference.

### BACKGROUND

In manufacturing a semiconductor device, various thin films, such as a silicon dioxide film or a silicon nitride film, are formed by using a film-forming apparatus comprising a chemical vapor deposition reaction chamber (CVD reaction chamber or chamber). In forming the thin film, the CVD reaction product is deposited not only on the surface of a target semiconductor wafer but also on the constituent members of the film-forming apparatus such as the wall of the CVD reaction chamber, the boat or susceptor for supporting the semiconductor wafer, or piping. The CVD reaction product deposited on the constituent members, if left unremoved, peels off from, for example, the inner wall of the CVD reaction chamber. This generates particles and results in degrading the semiconductor thin film formed on the wafer by the CVD reaction in the subsequent step. Thus, it is necessary to clean the film-forming apparatus.

Fluorine-containing gases have extensively been used to clean deposition chambers in semiconductor manufacturing processes. See, e.g., U.S. Pat. App. Pub. Nos. 2005/0082002 and 2006/0065289. In these cleaning methods, fluorine radicals generated by either thermal or plasma processes react with undesired CVD reaction product to form volatile compounds, such as SiF₄, which are then removed in gaseous form.

However, fluorine-containing molecules tend to be retained in the chamber wall and other surfaces after completion of the cleaning process. These molecules may adversely affect the quality of subsequently deposited films.

Purging with an inert gas is a common way to eliminate residual fluorine from the chamber. See, e.g., U.S. Pat. Nos. 5,326,723 to Intel Corp and 5,963,834 to Tokyo Electron Ltd. However, complete removal of the residual fluorine takes a long time. Thus, a thorough purge is necessary to eliminate the fluorine-containing molecules from the chamber prior to the next deposition process. JP2009-302555 and JP2005-079123, both to Kabushiki Kaisha Toshiba and the assignee of the present application, claim to remove fluorine-containing molecules left in the chamber after F₂+HF thermal cleaning by maintaining the chamber at 300° C. for at least 30 minutes to accelerate desorption of the molecules from the chamber surfaces. Therefore, even though high speed cleaning may now be achievable and arguably improve product throughput, a long post cleaning purge or desorption step may still be required, diminishing the benefits obtained by high speed cleaning.

Fluorine-containing molecules may be removed by the addition of O₂ plasma or by H₂ plasma utilization. For example, JP2003-178993 to Applied Materials, Inc. discloses the use of H₂ plasma to remove residual fluorine-containing molecules from the chamber. Similarly, JP2000-100729 to NEC Corp. discloses the removal of fluorine-containing molecules by the combination of H₂ plasma with Ar, which serves to improve the plasma density. EP 1154036, also to Applied Materials, Inc., discloses a two-step process to remove fluorine-containing molecules, a H₂ plasma step followed by a Si plasma step, which deposits a solid Si layer on the walls and fixtures of the chamber. The solid Si layer acts as an encapsulant, sealing any remaining fluorine-containing compounds behind the layer. U.S. Pat. No. 6,982,323 to Novellus Systems utilizes the plasma from a combination of an oxygen-containing gas and a hydrogen-containing gas to remove residual fluorine.

A plasma generator is needed to perform these methods, which may add to both equipment and operation expenses. Additionally, the combination of the fluorine-containing molecule with the dissociated hydrogen may produce HF, which is highly corrosive to the surfaces within the chamber. Therefore, a method to remove residual fluorine from the chamber without the use of plasma may help extend the life of the chamber and its constituent parts and reduce operating costs.

Accordingly, a need remains to remove residual fluorine from a semiconductor manufacturing chamber in a quick manner and without the introduction of a plasma.

### SUMMARY

Disclosed is a method of removing residual fluorine from the interior surfaces of a deposition chamber. After cleaning the deposition chamber with a fluorine-containing gas, a F removable gas is introduced into the deposition chamber. The F removable gas reacts with the residual fluorine without plasma to produce a reaction product. The reaction product is removed from the deposition chamber. The disclosed methods may include one or more of the following aspects:

the F removable gas comprising an oxygen source selected from the group consisting O₂, O₃, NO, N₂O, CO, and combinations thereof;

the F removable gas comprising NO.

the NO comprising between approximately 1% v/v and approximately 10% v/v of the F removable gas with a balance of nitrogen;

the F removable gas comprising CO;

the CO comprising between approximately 1% v/v and approximately 10% v/v of the F removable gas with a balance of nitrogen;

the F removable gas comprising NO and CO;

the NO comprising approximately 1% v/v of the F removable gas, the CO comprising approximately 1% v/v of the F removable gas, and nitrogen comprising a remainder of the F removable gas;

the temperature of the deposition chamber during the reaction step being between approximately 200° C. to approximately 300° C.; and

monitoring the reaction product during the removal step to determine if any residual fluorine remains in the deposition chamber.

### BRIEF DESCRIPTION OF THE FIGURES

For a further understanding of the nature and objects of the present invention, reference should be made to the following detailed description, taken in conjunction with the accompanying figure wherein:

the figure is a graph of fluorine ion intensity as a function of purging time.

### DESCRIPTION OF PREFERRED EMBODIMENTS

Disclosed herein are non-limiting embodiments of methods, apparatus, and compounds which may be used in the manufacture of semiconductor, photovoltaic, LCD-TFT, or flat panel type devices.

The disclosed methods remove residual fluorine from surfaces within a film-forming apparatus without the use of a plasma device or temperature elevation. Residual fluorine includes any atoms or molecules containing at least one F element, whether neutral or having an ionic charge, including but not limited to F, F⁻, and F₂. Removal of the residual fluorine permits the next step in the deposition process to occur more quickly.

As discussed previously, deposits formed in a film-forming apparatus, for example, on exposed surfaces such as the walls, may be removed by a fluorine-containing gas. Exemplary deposits include but are not limited to SiO₂, SiN, SiON, polysilicon, amorphous-silicon, microcrystalline silicon, Ti, TIN, Ta, TaN, W, and WO. The fluorine-containing gas reacts with the deposits to form, for example, SiF₄, TaF₄, and VVF₆, which are removed from the film-forming apparatus either as or with volatile compounds in the cleaning process.

The disclosed method introduces one or more “F removable gases” into the film-forming apparatus after cleaning it of the deposits with a fluorine-containing gas. The F removable gas comprises an inert gas diluent combined with an oxygen source selected from the group consisting O₂, O₃, NO, N₂O, CO, and combinations thereof. The inert gas diluent may be N₂, Ar, He, or mixtures thereof. As will be discussed in further detail in the examples that follow, Applicants have successfully tested NO/N₂ and CO/N₂ combinations as the F removable gas and, based upon this testing, anticipate that other combinations of the disclosed components may work equally as well. The F removable gas may be provided in a cylinder or generated onsite by mixing the relevant gaseous components.

The F removable gas comprises between approximately 1% v/v to approximately 100% v/v of O₂, O₃, NO, N₂O, CO, or combinations thereof, and preferably between approximately 1% v/v to approximately 10% v/v. One of ordinary skill in the art will recognize that lower concentrations of the oxygen source may be preferable for at least economic reasons.

The terms “after” or “subsequent to” are used to indicate that the F removable gas is not introduced into the film-forming apparatus at the same time as the fluorine-containing gas. Instead, introduction of the F removable gas follows cessation of delivery of the fluorine-containing gas used in the cleaning process.

As some fluorine-containing cleaning gases may include an oxygen source, such as NO or CO, the F removable gas introduction step may simply comprise stopping the flow of the fluorine-containing component of the cleaning gas. One of ordinary skill in the art will recognize that such an embodiment requires generation of the fluorine-containing cleaning gas on site by, for example, in-line mixing of the components of the cleaning gas. In other words, if the fluorine-containing cleaning gas is provided in a cylinder, stopping the flow of the fluorine-containing component of the cleaning gas to permit introduction of the F removable gas (i.e., an oxygen source and inert gas) would be impossible. In that situation, the fluorine-containing cleaning gas and F removable gas would be introduced subsequently via separate cylinders.

The film-forming apparatus includes, for example, a CVD reaction chamber, and introduction and exhaust lines (pipes) for CVD raw material gases. A member designed to hold a semiconductor wafer on which the film is to be formed (for example, a boat in the case of a batch type film-forming apparatus or a susceptor in the case of a single wafer type film-forming apparatus) is arranged within the film-forming apparatus. The constituent members of the film-forming apparatus include the CVD reaction chamber, the piping attached to the CVD reaction chamber and the member designed to hold a semiconductor wafer.

In general, the walls of the CVD reaction chamber, whether a batch type or a single wafer type film-forming apparatus, may be formed of quartz or aluminum oxide (Al₂O₃), On the other hand, the member designed to hold a semiconductor wafer is generally formed of quartz, silicon carbide (SiC) or a carbon material having its surface coated with silicon carbide. The film-forming apparatus may be used to form a film. The pipes are usually formed of quartz or stainless steel.

The F removable gas is introduced into the reaction chamber and reacts with residual fluorine from the cleaning process. The F removable gas may be introduced into the chamber at a flow rate between approximately 1 slm to approximately 10 slm. The chamber is maintained at a pressure ranging from approximately 10 Torr to approximately 400 Torr, and preferably from approximately 100 Torr to approximately 300 Torr.

The temperature of the chamber may range from approximately 200° C. to approximately 400° C., and preferably from approximately 200° C. to approximately 300° C. The preferred temperature helps to commence the reaction between F and the oxygen source. Additionally, as the cleaning process is typically implemented at approximately 300° C. to approximately 400° C., a significant change in the chamber temperature, and accompanying delay in production, prior to introduction of the F removable gas may not be required.

The oxygen source in the F removable gas may react with residual fluorine in the reaction chamber, even at temperatures between approximately 15° C. and approximately 40° C. As the reaction between the residual fluorine and F removable gas may occur at room temperature, plasma and/or heating is not required to perform the disclosed method. For example, NO exothermically reacts with F₂ at ambient temperature to form FNO and minor amounts of F₃NO. CO also reacts with F₂ at ambient temperature, though not as quickly as NO and F₂, to form COF₂. Applicants believe that O₂, O₃, and N₂O will react with fluorine to produce OF2 and/or FNO, Unlike F₂, these reaction products do not appear to be retained in the chamber wall or other chamber surfaces. Therefore, the reactant products are easily removed from the chamber. This enables a short turn around time between manufacturing steps, in that the next deposition process may begin instantly, or much quicker than previously possible.

The reactant products are removed from the chamber via the exhaust line of the chamber. In one embodiment, the flow rate of the F removable gas and the pressure of the chamber force the reactant products from the chamber via the outlet port. In effect, the F removable gas travels through the chamber, carrying the reactant products with it and through the chamber outlet port. In another embodiment, the F removable gas may be introduced and retained in the chamber for a period of time. The chamber may then be evacuated under its own pressure, with the assistance of a vacuum, or with the assistance of a purge gas such as nitrogen, thereby removing the F removable gas and reactant products from the chamber.

Mass spectrometry, non-dispersive infrared (NDIR), or Fourier-transform infrared sensors may be used to detect byproducts in the exhaust from the outlet port to determine if any residual fluorine remains in the chamber. Although F₂ does not adsorb infrared light, infrared sensors may be used to detect the FNO and COF₂ peaks in the effluent gas. Monitoring these peaks provides an indirect indication of the amount of residual fluorine remaining in the chamber.

### Examples

The following non-limiting examples are provided to further illustrate embodiments of the invention. However, the examples are not intended to be all inclusive and are not intended to limit the scope of the inventions described herein.

### Example 1

### F removable efficiency

In the first test, a simulated deposition chamber made of aluminum oxide was dynamically in contact with a fluorine-containing cleaning gas (300° C., 100 Torr) for 30 minutes. In this process, residual fluorine molecules attached on the chamber wall and remained. After removal of the fluorine-containing cleaning gas, a 1% v/v NO in N₂ admixture was introduced into the chamber (at 500 sccm, 100 Torr, 300° C.).

In the second test, the fluorine contamination of the deposition chamber was repeated and a 1% v/v CO in N₂ admixture was introduced into the chamber (at 500 sccm, 100 Torr, 300° C.) exposed with F₂.

In the third test, the fluorine contamination of the deposition chamber was repeated again and, as a control, only N₂ was introduced into the chamber heated at 300° C. (500 sccm, 100 Torr) to purge out residual fluorine molecules from the chamber surface.

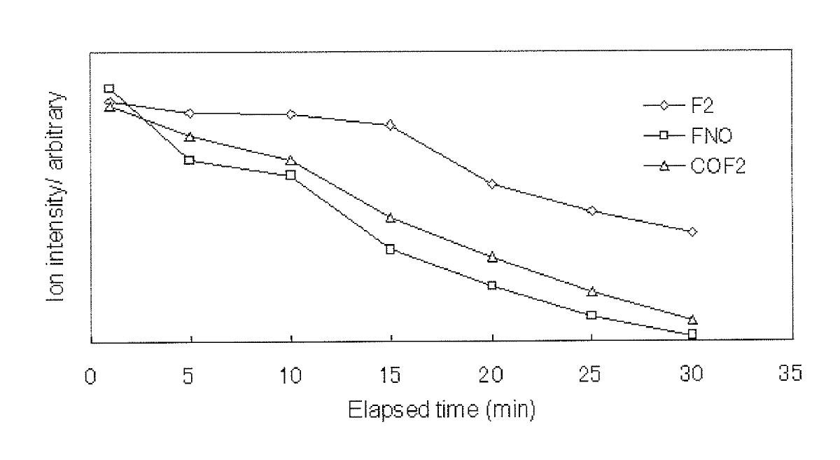

In all three tests, the effluent exiting the chamber was continuously monitored by mass spectroscopy (MS) to analyze residual fluorine content entrained with N₂. The results are summarized in FIG. 1.

Based upon these results, residual fluorine content (FNO or COF₂) was reduced after 30 minutes when using the disclosed F removable gas composition (e.g., either NO or CO in dilution with N₂). In contrast N₂ purging alone was less effective in removing residual fluorine (F₂), even after 30 minutes. In fact, higher amounts of residual fluorine (F₂) clearly remain in the chamber effluent during N₂ purging. FIG 1 illustrates that the addition of the oxygen source to the N₂ purge resulted in the elimination of residual fluorine from the chamber faster than N₂ purging alone.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method of removing residual fluorine from exposed surfaces of a deposition chamber, the method comprising the steps of:
cleaning the deposition chamber with a fluorine-containing gas;
subsequently introducing a F removable gas into the deposition chamber;
reacting the F removable gas with the residual fluorine without plasma to produce a reaction product; and
removing the reaction product from the deposition chamber.

2. The method of claim 1, wherein the F removable gas comprises an oxygen source selected from the group consisting O₂, O₃, NO, N₂O, CO, and combinations thereof.

3. The method of claim 2, wherein the F removable gas comprises NO.

4. The method of claim 3, wherein the NO comprises between approximately 1% v/v and approximately 10% v/v of the F removable gas with a balance of nitrogen.

5. The method of claim 2, wherein the F removable gas comprises CO.

6. The method of claim 5, wherein the CO comprises between approximately 1% v/v and approximately 10% v/v of the F removable gas with a balance of nitrogen.

7. The method of claim 2, wherein the F removable gas comprises NO and CO.

8. The method of claim 7, wherein the NO comprises approximately 1% v/v of the F removable gas, the CO comprises approximately 1% v/v of the F removable gas, and nitrogen comprises a remainder of the F removable gas.

9. The method of claim 1, wherein a temperature of the deposition chamber during the reaction step is between approximately 200° C. to approximately 300° C.

10. The method of claim 1, further comprising monitoring the reaction product during the removal step to determine if any residual fluorine remains in the deposition chamber.
